(19) United States
(12) Patent Application Publication
(10) Pub. No.: US 2009/0035447 A1
(43) Pub. Date: Feb. 5, 2009

(54) METHODS OF MAKING DISPOSABLE GLOVES

(76) Inventor: Paul L. Bottcher, Lakemoor, IL (US)

Correspondence Address: Nixon Peabody LLP, 161 North Clark Street, 48th Floor, Chicago, IL, 60601, US

(21) Appl. No.: 12/244,468

(22) Filed: Oct. 2, 2008

Related U.S. Application Data
(62) Division of application No. 11/280,885, filed on Nov. 15, 2005.
(60) Provisional application No. 60/656,654, filed on Feb. 25, 2005.

(51) Int. Cl. B05D 1/18

(52) U.S. Cl. 427/2.3

(57) ABSTRACT

A disposable glove and a method for making the disposable glove that reduces or eliminates glove cuff roll-down. The disposable glove includes a coating on the interior surface of the glove that extends from the hand area to a portion of the wrist-forearm area of the glove but does not include coating on the portion of the wrist-forearm area containing the beaded cuff and cuff portion. The uncoated portion of the interior surface of the disposable glove resists glove cuff roll-down when the glove is positioned on a user's hand and forearm.

### CROSS-REFERENCE TO RELATED APPLICATION

This application claims the benefit of priority of U.S. Provisional Application No. 60/656,654, filed Feb. 25, 2005, which is hereby incorporated by reference in its entirety.

### FIELD OF THE INVENTION

The present invention relates to medical grade disposable examination and surgical gloves and methods of making these gloves that reduce or eliminate the occurrence of glove cuff roll-down.

### BACKGROUND OF THE INVENTION

Disposable medical gloves are widely used as a protective measure and have become mandatory in many industries and nearly all medical settings. In particular, disposable gloves are required as a means for protecting medical staff from coming into contact with bodily fluids during surgical procedures, medical examinations, laboratory testing and other medical procedures. Disposable gloves have traditionally been made of rubber materials such as latex, thermoplastic materials such as vinyl, and other natural and synthetic materials. Often the disposable gloves, particularly powder-free disposable gloves, have a coating on the interior surface of the disposable gloves to make donning of the gloves easier. Coatings, particularly polymer coatings, have been used in place of powder in disposable gloves to reduce the occurrence of allergic reactions to the powder by users of the gloves.

In addition to gloves, medical staff must also wear other protective garments, such as surgical gowns to protect them from coming into contact with bodily fluids. A surgical gown is typically placed over the torso and arms of a surgeon or other medical staff member. Disposable gloves are then placed on the hands and forearms of a surgeon while he or she is wearing the surgical gown. A portion of the disposable glove is placed over the sleeve of the surgical gown to ensure that no portion of the surgeon's arm or hand is exposed during a medical procedure. The surgical gowns and gloves help to prevent the surgeon from coming into contact with bodily fluids. Also, by using sterile gloves, gowns and other protective apparel, the patient is better protected from acquiring infections, etc.

Recently, surgical gown manufacturers have begun to produce surgical gowns that are manufactured with materials such as spunlace and blends of polyester, polypropylene and polyethylene. Surgical gowns manufactured from these materials are generally more slippery than surgical gowns of the past that were made out of cloth fabrics. These new materials are designed to more effectively repel bodily fluids with which a surgeon may come into contact.

The use of these materials in surgical gowns, in combination with the use of disposable gloves having coatings on the interior surfaces of the gloves, has produced problems for medical staff. Specifically, as coated disposable gloves are placed over the sleeves of existing surgical gowns, the inner surface of the coated disposable gloves contacts the slippery outer surface of the surgical gown and causes the gloves to roll down the arm or the wrist-forearm of the surgical gown. This problem, often referred to as glove cuff roll-down, permits for the possibility of contamination due to the exposure of the surgeon's arm, hand or wrist-forearm. This contamination may affect the surgeon, medical staff and patient, possibly exposing them to infectious agents, such as Hepatitis B, Hepatitis C and HIV.

The glove cuff roll-down problem has provided challenges for those in the protective garment industry, particularly glove manufacturers, who manufacture disposable products having coated surfaces to provide gloves that resist glove cuff roll-down. The present invention addresses this problem by providing gloves and methods of making gloves that reduce the occurrence of glove cuff roll-down.

### SUMMARY OF THE INVENTION

According to one embodiment of the present invention, a disposable glove comprises a first area including a hand area and a second area. The hand area includes a palm area and a plurality of finger-receiving receptacles. The second area includes a wrist-forearm area. The wrist-forearm area includes a beaded cuff and a cuff portion. The disposable glove has a coating on an interior surface of the disposable glove. The coating on the interior surface of the disposable glove covers the first area and a portion of the second area such that the beaded cuff and the cuff portion are uncoated and resistant to glove cuff roll-down.

According to another embodiment of the present invention, a method for making a disposable glove comprises forming the disposable glove on a former. The disposable glove includes a first area and a second area. The first area includes a hand area, including a palm area and a plurality of finger-receiving receptacles. The second area includes a wrist-forearm area. The method comprises dipping the disposable glove into a coating such that the hand area and a portion of the wrist-forearm area are coated with the coating and a portion of the wrist-forearm area remains uncoated. The method further comprises removing the disposable glove from the former and inverting the disposable glove so that the coating is on an interior surface of the disposable glove. The uncoated portion of the wrist-forearm area reduces glove cuff roll-down when the disposable glove is worn by a user.

According to another embodiment of the present invention, a disposable glove comprises a flexible body article shaped like a hand comprising finger-receiving receptacles, a palm area and a wrist-forearm area. The wrist-forearm area includes a beaded cuff and a cuff portion. The article has an interior surface which includes a coated region and a substantially uncoated region. The coated region includes the finger-receiving receptacles, the palm area, and a portion of the wrist-forearm area. The substantially uncoated region includes the beaded cuff and the cuff portion. The substantially uncoated region helps to reduce the occurrence of glove cuff roll-down.

According to another embodiment, a disposable glove comprises a first area including a hand area and a second area. The hand area includes a palm area and a plurality of finger-receiving receptacles. The second area including a wrist-forearm area. The wrist-forearm area includes a beaded cuff and a cuff portion. The disposable glove has a coating on an interior surface of the disposable glove. The coating on the interior surface of the disposable glove covers the first area and a portion of the second area such that the beaded cuff and the cuff portion are substantially uncoated and resistant to glove cuff roll-down.

According to a further embodiment, a method for making a disposable glove comprises forming the disposable glove on a former. The disposable glove includes a first area and a second area. The first area includes a hand area, including a palm area and a plurality of finger-receiving receptacles. The second including a wrist-forearm area. The method also comprises dipping the disposable glove into a coating such that the hand area and a portion of the wrist-forearm area are coated with the coating and a portion of the wrist-forearm area remains substantially uncoated. The method further comprises removing the disposable glove from the former and inverting the disposable glove so that the coating is on an interior surface of the disposable glove. The substantially uncoated portion of the wrist-forearm area reduces glove cuff roll-down when the disposable glove is worn by a user.

### BRIEF DESCRIPTION OF THE DRAWINGS

FIG. 1 illustrates a disposable glove with a cutaway portion of the wrist-forearm area according to one embodiment of the present invention.

FIG. 2 illustrates the disposable glove of FIG. 1 prior to being stripped from its former.

FIG. 3 illustrates a diagrammatic representation of the apparatus used to carry out the method for making the disposable glove of FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

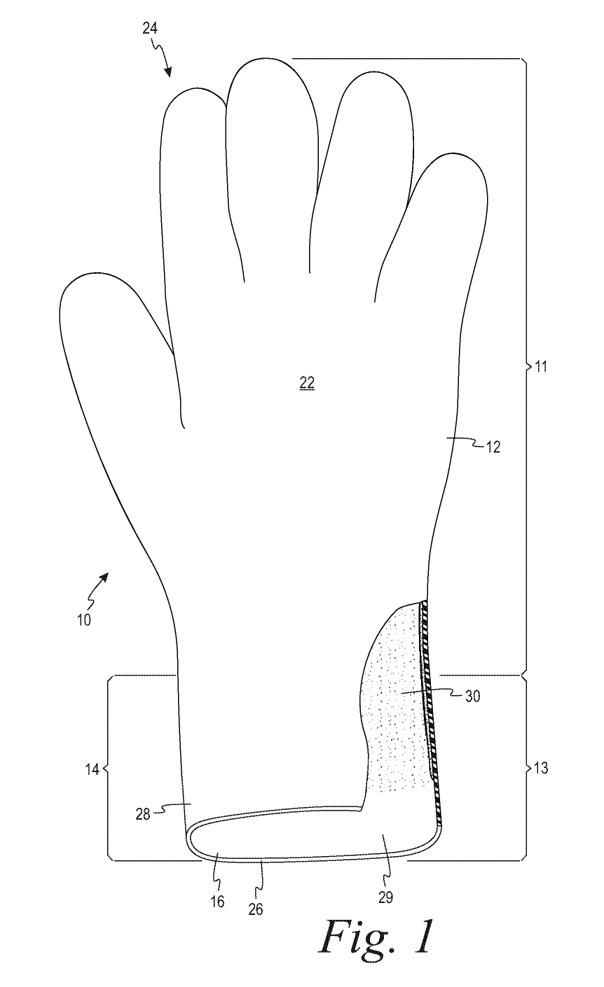

FIG. 1 illustrates a disposable glove 10 according to embodiments of the present invention. The disposable glove 10 comprises a hollow flexible body article having a first area 11 and a second area 13. The first area 11 includes a hand area 12. The second area 13 includes and a wrist-forearm area 14. The disposable glove 10 has an open end 16 into which a hand is inserted. The hand area 12 includes a palm area 22 and a plurality of finger-receiving receptacles 24. The wrist-forearm area 14 includes a beaded cuff 26 and a cuff portion 28. The disposable glove 10 may be made of various materials, including natural rubber latex and/or synthetic rubber materials such as polyisoprene, styrene-isoprene-styrene, copolymer blends, neoprene (polychloroprene), nitrile, vinyl, polyurethane, and combinations thereof as well as other materials suitable for use in disposable medical gloves. For example, some disposable gloves are made with materials such as a polyisoprene/neoprene blend.

The thickness of the disposable glove 10 may vary depending on the surgical procedure being performed. For instance, gloves used in eye procedures are generally thinner to allow for greater sensitivity for the surgeon. Gloves used in orthopedic procedures are generally required to be thicker because of the wear and tear the glove may take. Most gloves range from about 5.5 mil thickness to about 13 mil thickness (measured as a single wall thickness). The minimum thickness for a surgical glove is required to be about 4 mils per FDA regulations as defined by ASTM standards.

The wrist-forearm area 14 of FIG. 1 has been cutaway to show the interior surface 29 of the disposable glove 10. A portion of the interior surface 29 of the disposable glove 10 includes a coating 30 attached to and integrally formed with the interior surface 29 of the disposable glove material. In some embodiments, the coating 30 may include a polymer coating. Polymer coatings have been used in place of powder in disposable gloves to reduce the occurrence of allergic reactions to the powder by users of the gloves. Polymer coatings that may be used with the present invention may include a polyacrylate resin emulsion or any other polymers or emulsions that achieve the desired level of donnability of the disposable glove 10. Moreover, any material that is applied to the disposable glove 10 after it is formed may be considered a coating, whether it is a polymer, an emulsion or other suitable material.

It is contemplated that more than one coating can be applied to the interior surface 29 of the disposable glove 10. It is also contemplated that the coating 30 may be applied to different portions of the interior surface 29 of the disposable glove 10 other than the portions shown in FIG. 1. The location of the coating on the interior surface 29 of the disposable glove 10 and the presence of more than one coating are features that may be modified based on cost considerations, the desired level of donnability of the disposable glove 10, ease of application of the coating, production capabilities, etc.

The density of the coating 30 must be such that the coating 30 attaches to the portion of the interior surface 29 of the disposable glove 10 to achieve the desired benefits, e.g., easier donnability and double gloving. Double gloving is used by some medical staff to increase the level of protection as wearing two gloves offers greater protection than wearing a single glove. By using disposable gloves 10 with a coating 30 on the interior surface 29 of the disposable gloves 10, the surgeon and/or medical staff can effectively don and double glove the gloves without the need for harmful absorbable dusting powders that are added to some gloves to aid in donning. The elimination of powder in gloves is desirable for the end user and patients who may have allergies to the dusting powders. In addition to the coating 30 described above, the disposable glove 10 may also be coated with other substances that add to the performance of the disposable glove 10, such as, but not limited to, aloe, moisturizers, anti-bacterial agents, anti-fungal agents or combinations thereof. These other substances may be applied to the interior surface 29 of the disposable glove 10 independently of the coating 30. Additionally or alternatively, the coating 30 may include these other substances.

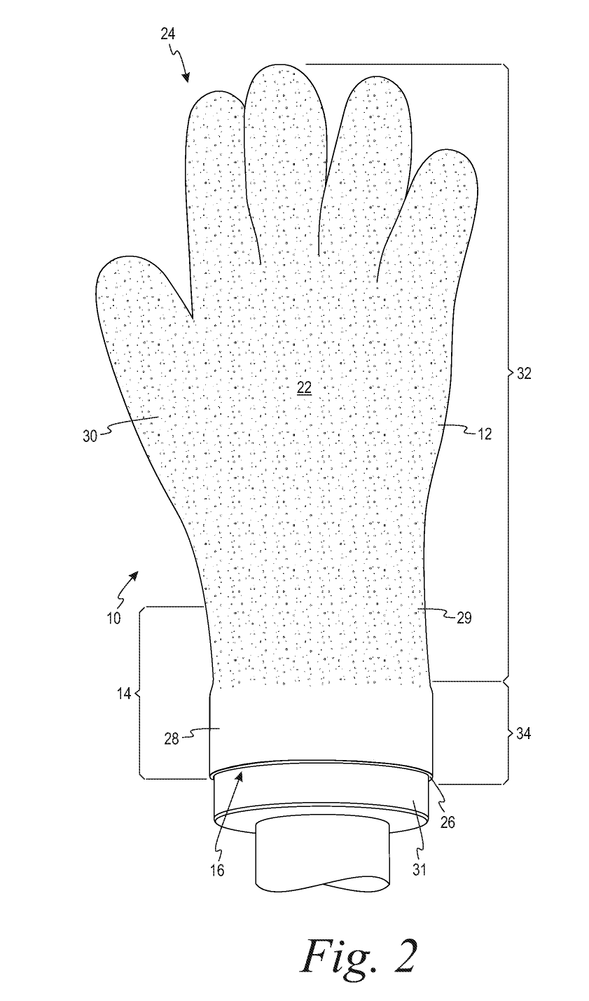

The disposable gloves 10 of the present invention may be formed on a series of formers in the shape of a hand. FIG. 2 illustrates the disposable glove 10 of FIG. 1 on a former 31. While on the former 31, the interior surface 29 of the disposable glove 10 is exposed. As shown in FIG. 2, according to one embodiment, a selected portion 32 of the interior surface 29 is coated with the coating 30 beginning from the finger-receiving receptacles 24 extending to and including a portion of the wrist-forearm area 14. However, a portion 34 of the interior surface 29 that includes the beaded cuff 26 and the cuff portion 28 is not coated or is at least substantially not coated. In other words, while the embodiments of the present invention described herein include a disposable glove 10 having a portion 34 of the interior surface 29 that is not coated (namely the beaded cuff 26 and the cuff portion 28), it is possible that a small area(s) of the beaded cuff 26 and the cuff portion 28 may contain a nominal amount of the coating 30 due to, for example, slight variances in the dipping process described below.

The uncoated or substantially uncoated portions 34 of the interior surface 29, namely the beaded cuff 26 and the cuff portion 28, help to reduce or eliminate the occurrence of glove cuff roll-down. Glove cuff roll-down occurs when the interior surface 29 of the disposable glove 10 which is at least partially coated comes in contact with the sleeve material of the surgical gown or other protective garment and, due to the slippery nature of the coating and the material used in the gown or other protective garment, causes the gown or other protective garment to slide down the arm or wrist-forearm of a user. Although not intending to be bound by the particular theory or theories disclosed herein, it is believed that the reduction or elimination of glove cuff roll-down is achieved because the interior surface of the disposable gloves made from natural rubber latex and/or synthetic rubber materials is tacky when exposed in an uncoated state. The tacky portion, namely the uncoated or substantially uncoated portion 34, of the disposable glove 10 that does not become coated with the coating 30 is believed to grip the gown sleeves and the gown/protective garment material more effectively.

The uncoated or substantially uncoated portion 34 (including the uncoated beaded cuff 26 and the uncoated cuff portion 28), when measured from the edge of the beaded cuff 26 in the direction of the finger-receiving receptacles 24, may vary in length depending on the size of the disposable glove. Surgical gloves generally range from about size 5.5 through about size 9. The former length for a size 9 glove, for example, is longer than the former length for a size 5.5 glove. The size of the glove in combination with the arrangement of the glove production line may create a variance in the amount of coating 30 that does not become added to the surface of the glove, i.e., the length of the uncoated or substantially uncoated portion 34.

As explained above, in one embodiment, the desired coated portion 32 includes the finger-receiving receptacles 24 and extends to the wrist-forearm area 14. The uncoated or substantially uncoated portion 34 includes the beaded cuff 26 and cuff portion 28 of the wrist-forearm area 14. According to one embodiment, the uncoated or substantially uncoated portion 34 may range from about 0.25 inch to about 5 inches when measured from the edge of the beaded cuff 26 in the direction of the finger-receiving receptacles 24. In some embodiments, the uncoated or substantially uncoated portion 34 is about 2 to about 3 inches when measured from the edge of the beaded cuff 26 in the direction of the finger-receiving receptacles 24. The uncoated beaded cuff 26 and the uncoated cuff portion 28 are believed to adhere to the sleeve material of the surgical gown or the other protective garment and resist glove cuff roll-down due to the gripping of the beaded cuff 26 and the cuff portion 28 to the sleeve material of the surgical gown or the other protective garment.

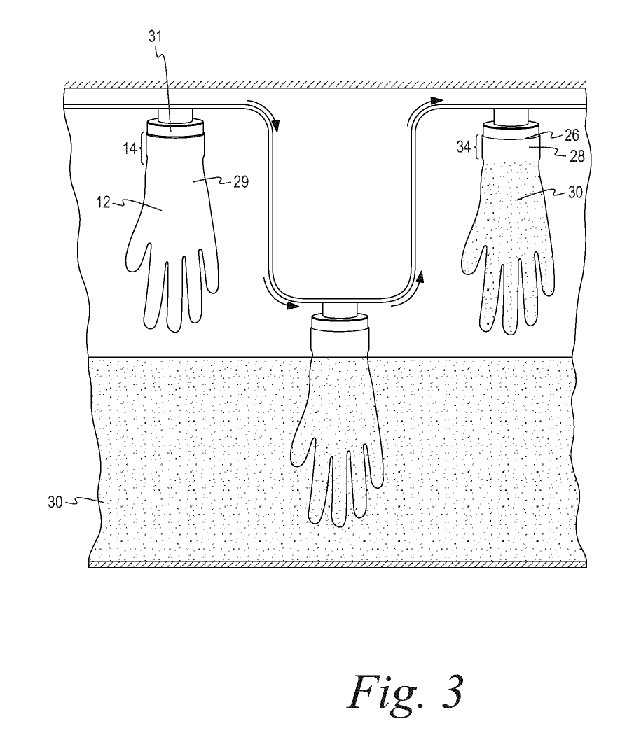

Turning to FIG. 3, an apparatus used to carry out the method of making the disposable gloves 10 described above is shown according to one embodiment of the present invention. A former 31 shaped like a hand is dipped into a first tank of latex or other suitable glove-forming material(s) (not shown). In some embodiments, the former 31 may be dipped a second or more times into the first tank of latex or other suitable glove-forming material(s) to reinforce the disposable glove 10 as it is formed on the former 31. It is also contemplated that the former 31 could be dipped one or more times into additional glove-forming tank(s) that include latex and/or other suitable glove-forming material(s). Non-limiting examples of suitable materials for use in the first tank or the additional glove-forming tank(s) are described above and include natural rubber latex as well as synthetic rubber materials such as polyisoprene, styrene-isoprene-styrene, copolymer blends, neoprene (polychloroprene), nitrile, vinyl, polyurethane, and combinations thereof as well as other materials suitable for use in disposable medical gloves. The number of dips or the types of material(s) in the tank(s) may depend on cost considerations, the desired level of donnability of the disposable glove 10, ease of application of the coating, production capabilities, etc. The former 31 containing the latex or the other suitable glove-forming material(s) formed by this dipping process may then be cured to form the disposable glove 10 having a hand area 12 and a wrist-forearm area 14. At this point, the disposable glove 10 is in an inverted position on the former 31, with the interior surface 29 of the disposable glove 10 exposed.

The disposable glove 10 formed by the dipping process as described above is, in one embodiment, then dipped into a tank containing the coating 30 as shown in FIG. 3 such that less than all of the disposable glove 10 is immersed in the tank containing the coating 30. The coating 30 attaches to the exposed surface of the disposable glove 10. In some embodiments, the disposable glove 10 may be dipped a second or more times into the tank containing the coating 30. Non-limiting examples of suitable materials for use in the coating tank are described above and include a polyacrylate resin emulsion or any other polymers or emulsions that achieve the desired level of donnability of the disposable glove 10. Additionally or alternatively, it is also contemplated that the former 31 could be dipped into additional coating tanks containing other coating material(s) such as aloe, moisturizers, anti-bacterial agents, anti-fungal agents or combinations thereof. It is also contemplated that any of these other coating material(s) such as the aloe, the moisturizers, the anti-bacterial agents, the anti-fungal agents or combinations thereof could be included in the tank or any of the contemplated coating tank(s) that contain one or more suitable coating material(s). The number of dips or the types of coating material(s) in the tank(s) may depend on cost considerations, the desired level of donnability of the disposable glove 10, ease of application of the coating, production capabilities, etc.

According to one embodiment of the present invention, the disposable glove 10 is dipped into the tank of coating 30 such that only the hand area 12 and a portion of the wrist-forearm area 14 are inserted into the coating 30, leaving a portion 34 of the interior surface 29 of the disposable glove 29 uncoated or substantially uncoated. As shown in FIG. 3, the cuff portion 28 and the beaded cuff 26 are not immersed in the coating 30 and remain uncoated or substantially uncoated, forming the disposable glove 10 as depicted in FIG. 2.

After the dipping stage shown in FIG. 3, the disposable gloves 10 are inverted so that the coating 30 is on the inside of the disposable glove 10 as depicted in FIG. 1. The disposable gloves 10 are then stripped off of the production line, sorted, cleaned/washed, processed, packed, inspected and sterilized. The resulting disposable gloves 10 possess improved functional characteristics which permit users to wear the disposable gloves 10 with surgical gowns or other protective garments without suffering from problems relating to glove cuff roll-down.

Examples of disposable gloves that may be used with the present invention include, but are not limited to, the AloeTouch®, Triumph® and Eudermic™ Powder-Free Latex Gloves, the Classic Powdered Latex Gloves such as the OR Classic™, and the Sensicare® and Neolon® Powder-Free, Latex-Free Surgical Gloves manufactured by Medline Industries, Inc. in Mundelein, Ill. The present invention is not limited to the specific gloves described above or use in connection with the specific gloves described above. Other disposable gloves may be manufactured according to the present invention. It is also contemplated that other methods of coating less than all of the interior surface 29 of the disposable glove 10 may be used to produce disposable gloves 10 that reduce the occurrence of glove cuff roll-down.

According to alternative embodiment A, a disposable glove comprises a hand area and a wrist/forearm area, the wrist/forearm area includes a beaded cuff and cuff portion, the disposable glove has a coating on the inner surface of the glove including the hand area and a portion of the wrist/forearm area that does not include the beaded cuff or cuff portion such that the beaded cuff and cuff portion are uncoated and resistant to cuff roll-down.

According to alternative embodiment B, the disposable glove of alternative embodiment A wherein the uncoated beaded cuff and cuff portion are approximately 0.25 inch to approximately five inches in length.

According to alternative embodiment C, a method for making a disposable glove comprises forming the disposable glove on a former having a hand area and a wrist/forearm area; dipping the disposable glove into a coating such that the hand area and a portion of the wrist/forearm area are coated with the coating and leaving a portion of the wrist/forearm area uncoated; and removing the disposable glove from the former and inverting the disposable glove so that the coating is on the interior of the disposable glove; wherein a portion of the wrist/forearm area remains uncoated and reduces cuff roll-down when the disposable glove is worn by a user.

According to alternative embodiment D, the method of alternative embodiment C wherein the portion of the wrist/forearm area that is uncoated is comprised of a beaded cuff and cuff portion.

According to alternative embodiment E, the method of alternative embodiment D wherein the uncoated beaded cuff and cuff portion are approximately 0.25 inch to approximately five inches in length.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following claims.

1-8. (canceled)

9. A method for making a disposable glove comprising:
forming the disposable glove on a former, the disposable glove including a first area and a second area, the first area including a hand area, the hand area including a palm area and a plurality of finger-receiving receptacles, the second area including a wrist-forearm area;
dipping the disposable glove into a coating such that the hand area and a portion of the wrist-forearm area are coated with the coating and a portion of the wrist-forearm area remains uncoated; and
removing the disposable glove from the former and inverting the disposable glove so that the coating is on an interior surface of the disposable glove and the uncoated portion of the wrist-forearm area reduces glove cuff roll-down when the disposable glove is worn by a user.

10. The method of claim 9, further comprising dipping the disposable glove in the coating a second time such that the uncoated portion of the wrist-forearm area remains uncoated.

11. The method of claim 9, further comprising dipping the disposable glove in a second coating such that the uncoated portion of the wrist-forearm area remains uncoated.

12. The method of claim 9, wherein the uncoated portion of the wrist-forearm area includes a beaded cuff and a cuff portion.

13. The method of claim 12, wherein the length of the uncoated beaded cuff and the uncoated cuff portion when measured from an edge of the uncoated beaded cuff in the direction of the finger-receiving receptacles is about 0.25 inch to about 5 inches.

14. The method of claim 13, wherein the length of the uncoated beaded cuff and the uncoated cuff portion when measured from the edge of the uncoated beaded cuff in the direction of the finger-receiving receptacles is about 2 inches to about 3 inches.

15. The method of claim 9, further comprising dipping the former into a tank containing a natural rubber latex.

16. The method of claim 9, further comprising dipping the former into a tank containing a synthetic rubber material, wherein the synthetic rubber material includes polyisoprene, styrene-isoprene-styrene, copolymer blends, polychloroprene, nitrile, vinyl, polyurethane or combinations thereof.

17. The method of claim 9, wherein the dipping step includes dipping the disposable glove into a coating that comprises a polyacrylate resin emulsion.

18. The method of claim 9, wherein the dipping step includes dipping the disposable glove into a coating that comprises aloe, moisturizers, anti-bacterial agents, anti-fungal agents or combinations thereof.

19. The method of claim 11, wherein the second coating comprises a polyacrylate resin emulsion.

20. The method of claim 11, wherein the second coating comprises aloe, moisturizers, anti-bacterial agents, anti-fungal agents or combinations thereof.

21-29. (canceled)

30. A method for making a disposable glove comprising:
forming the disposable glove on a former, the disposable glove including a first area and a second area, the first area including a hand area, the hand area including a palm area and a plurality of finger-receiving receptacles, the second including a wrist-forearm area;
dipping the disposable glove into a coating such that the hand area and a portion of the wrist-forearm area are coated with the coating and a portion of the wrist-forearm area remains substantially uncoated; and
removing the disposable glove from the former and inverting the disposable glove so that the coating is on an interior surface of the disposable glove and the substantially uncoated portion of the wrist-forearm area reduces glove cuff roll-down when the disposable glove is worn by a user.

31. The method of claim 30, further comprising dipping the disposable glove in the coating a second time such that the substantially uncoated portion of the wrist-forearm area remains substantially uncoated.

32. The method of claim 30, further comprising dipping the disposable glove in a second coating such that the substantially uncoated portion of the wrist-forearm area remains substantially uncoated.

33. The method of claim 30, wherein the substantially uncoated portion of the wrist-forearm area includes a beaded cuff and a cuff portion.

34. The method of claim 30, further comprising dipping the former into a tank containing a natural rubber latex.

35. The method of claim 30, further comprising dipping the former into a tank containing a synthetic rubber material, wherein the synthetic rubber material includes polyisoprene, styrene-isoprene-styrene, copolymer blends, polychloroprene, nitrile, vinyl, polyurethane or combinations thereof.

36. The method of claim 30, wherein the dipping step includes dipping the disposable glove into a coating that comprises a polyacrylate resin emulsion.

37. The method of claim 32, wherein the second coating comprises a polyacrylate resin emulsion.

38. A method for making a disposable glove comprising:
forming the disposable glove on a former, the disposable glove including a first area and a second area, the first area including a hand area, the hand area including a palm area and a plurality of finger-receiving receptacles, the second area including a wrist-forearm area;
coating the hand area and a portion of the wrist-forearm area with at least one coating while maintaining a portion of the wrist-forearm area uncoated for glove cuff roll-down reduction; and
removing the disposable glove from the former and inverting the disposable glove so that the at least one coating is on an interior surface of the disposable glove.
